(19) United States
(12) Patent Application Publication
(10) Pub. No.: US 2005/0086191 A1
(43) Pub. Date: Apr. 21, 2005

(54) Method for retrieving documents

(76) Inventor: Lars Werner, Soehrewald (DE)

Correspondence Address: MORRISON & FOERSTER LLP, 1650 TYSONS BOULEVARD, SUITE 300, MCLEAN, VA, 22102, US

(21) Appl. No.: 10/472,552

(22) PCT Filed: Mar. 20, 2002
(86) PCT No.: PCT/EP02/03126

(30) Foreign Application Priority Data
Mar. 23, 2001 (EP) 01107284.0

(51) Int. Cl. G06F 7/00

(52) U.S. Cl. 707/1

(57) ABSTRACT

The invention relates to a method for searching a document base in which documents are interlinked by links. A list of documents to be treated is sorted according to priority. The document pertaining to the highest priority is called up and the distance of said document to a document base is determined. All links from the document are entered into the list of documents to be treated, the distance of the document to the document base being used as the priority.

### CLAIM FOR PRIORITY

This application claims priority to International Application No. PCT/EP02/03126, which was published in the German language on Oct. 17, 2002, which claims the benefit of priority to German Application No. 01107284.0 which was filed in the German language on Mar. 23, 2001.

### TECHNICAL FIELD OF THE INVENTION

The invention relates to locating documents in a pool, in which the documents include references to other documents.

### BACKGROUND OF THE INVENTION

The system known as the World Wide Web (WWW) comprises a large number of documents that contain references to other documents, which in turn may contain references other documents, etc. Documents that conceal such references behind text or image objects are also known as hypertext, and the references themselves are referred to as hyperlinks. The hypertext documents on the WWW are normally coded in the HTML marking language.

To find a document in this largest existing pool of identically formatted documents, search engines have been known for some time. These search engines scan the documents at regular intervals and follow the hyperlinks. In this process, the documents are entered into an index consisting of either the index terms specified in the HTML or words extracted from the text. A user of the WWW who is searching for a document triggers a search of such an index using search terms he has specified.

Although this method was relatively effective during the early days of the WWW, the outcome set is only small enough to be useable if very specific search terms and key words can be used. Inexperienced users, in particular, often obtain outcome sets that are either too small or too large.

Accordingly, based on the search terms and key words, the documents are displayed in their order of relevance, wherein the relevance can contain commercially preferential treatment. The frequencies of words are generally used to establish relevance, as was already proposed in 1958 in the article titled “The Automatic Creation of Literature Abstracts,” by H. P. Luhn, IBM Journal, p. 159-165.

Nevertheless, a need continues to exist for an improved method that is also accessible to inexperienced users.

In this context, it is proposed, in U.S. Pat. No. 6,167,398, to calculate a dissimilarity between a reference document and each candidate document by means of a dissimilarity metric and then, after having searched through a predetermined or otherwise delimited number of documents, to place the document into a sequence using the established dissimilarities. Several different dissimilarity metrics are to be used in this process. A disadvantage of this solution is that a set of documents is initially made available and then each of the documents is analyzed. Therefore, it is still necessary to determine a subset of the documents using a key word search question.

In U.S. Pat. No. 6,144,973, it is proposed, during a search for documents in the WWW, to evaluate the references in a document on the basis of whether a predetermined degree of similarity to the original document exists. The references are either used, if a predetermined threshold is exceeded, or they are discarded, if the threshold is not reached. There are no provisions for parallel work or making adjustments for documents already found. The primary means of limiting the number of documents accessed consists in limiting the depth of search.

### SUMMARY OF THE INVENTION

The present invention is based on the recognition that the established degree of similarity can be advantageously used to control the subsequent search and rank the references to be searched. The use of improved measures of similarity and the vector space model contribute to this.

In one embodiment of the invention, there is a method for searching through a document base in which documents are linked by references. A list of the documents to be processed is sorted by priority. The document corresponding to the highest-priority entry is retrieved, and the dissimilarity between this document and a document base is determined. All references from the document are entered into the list of documents to be processed, wherein the dissimilarity of the document to the document base is used as priority.

### BRIEF DESCRIPTION OF THE DRAWINGS

The invention is described below in more detail with reference to the drawing, in which:

FIG. 1 shows a diagram illustrating the fundamental sequence according to the present invention.

### DETAILED DESCRIPTION OF THE INVENTION

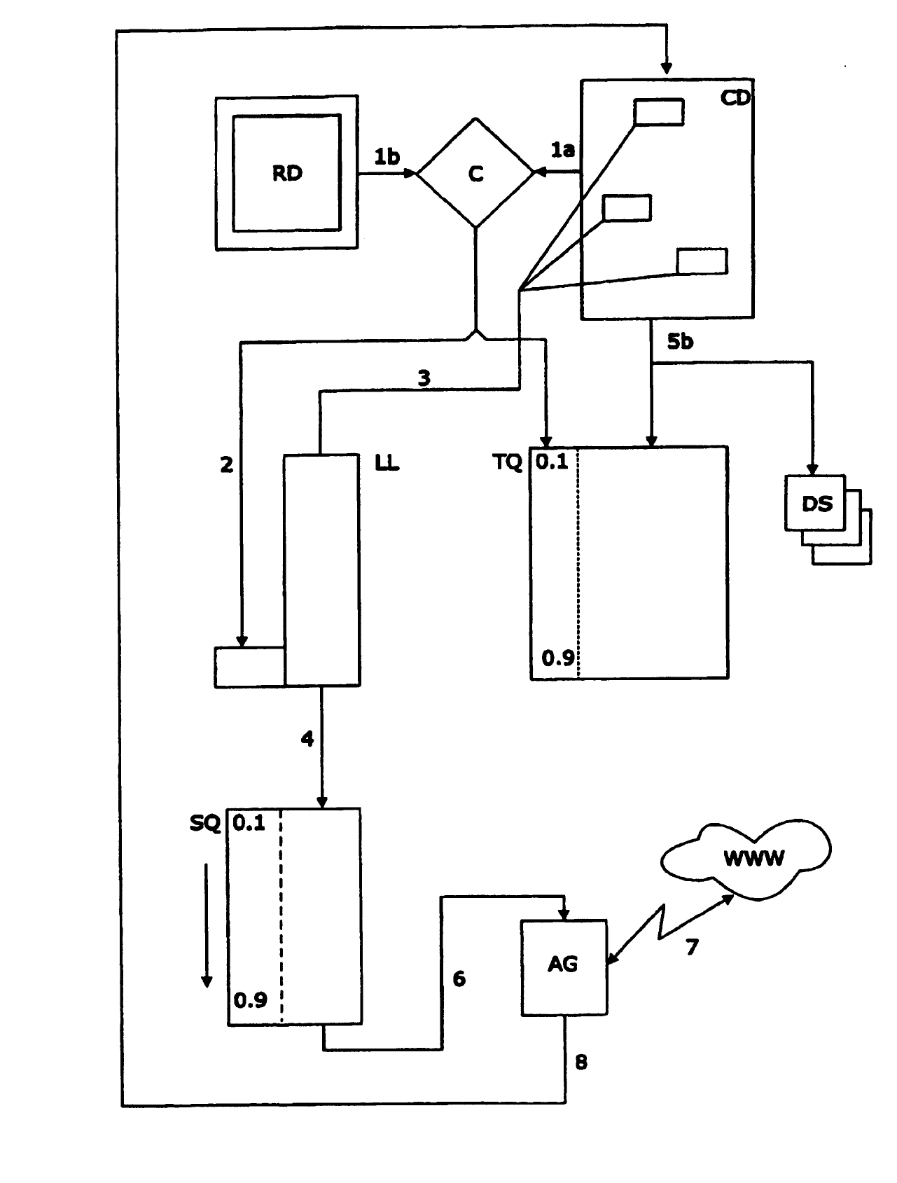

Referring to FIG. 1, two weighted waiting queues, the source queue SQ and the target queue TQ, are used. These queues are made available using conventional technology, particularly methods of object-oriented programming. In the following, it is assumed that the weight is a number between 0 and 1.

For each entry, the source queue SQ comprises at least one field for the weight, i.e. a number between 0 and 1, as well as a reference to the document to be considered, preferably in the form of a “uniform reference locator” (URL, reference to a document in the WWW). The entries in the source queue are sorted in such a way that the weight increases in the direction of the arrow and new entries are sorted in accordance with their weight.

The target queue TQ is similarly structured. It also includes, for each entry, a weight and a reference to a document, which in this case is portrayed as being located in a document storage DS, because the references always relate to documents that have been retrieved. The outcome of the method according to the invention arises in this target queue.

The method proceeds from an original document, which becomes the current document CD. There is also a comparison base RD of one or more documents.

In a first step, the current document CD and the reference document(s) RD, referred to as 1a and 1b, are fed into a comparator C which, using the vector space method, for example, determines a dissimilarity between the current document CD and the reference document RD.

Through formation of the inverse value, for example, this information is used to generate a weight as a number between 0 and 1, wherein a greater dissimilarity results in a smaller weight and vice-versa.

In step 2, the weight is provided for step 4.

In step 3, the references are extracted from the current document CD and collected in a reference list LL.

In step 4, the reference list LL and the weight provided in step 2 are transferred to the source queue SQ.

Thus, references included in the current document and the weight of the document including these references are entered into the source queue.

In the next step, the current document is entered into the target list TQ, wherein the determined weight 5a and the current document and a reference 5b thereto are entered into the target list. The current document itself is preferably filed in a document storage DS.

Step 6 is portrayed as the reference to the highest weight in the source queue SQ being taken from an agent AG and retrieved from the WWW, which is portrayed as step 7 in FIG. 1. The outcome, portrayed as step 8, is a document that now becomes the current document CD, and the method is then applied iteratively.

In a preferred emobidment, several agents are used instead of the agent AG portrayed in FIG. 1. This is because retrieving a document from the WWW can take a substantial amount of time. The simple transfer from step 8 is replaced by a buffer queue BQ (not shown), in which the retrieved documents are ranked according to the weights of the corresponding references in the source queue SQ. Once the respective current document CD has been analyzed and filed, the entry having what is then the highest weight in the buffer queue BQ is considered the current document. In this case, the documents are preferably entered into document storage DS immediately, leaving the references listed in the buffer queue BQ.

Working in parallel with several current documents CD is possible, especially when using computers with multiple processors.

Several measures known to a person skilled in the art, at least in principle, can be used to avoid overrun in the waiting queues. The buffer queue BQ can simply be provided with a fixed maximum length. An agent can become active only when a space is (or has become) available in the buffer queue BQ. Preferably, the number of agents is dynamically adjusted so that the buffer queue is always partially filled.

It is also possible to set a maximum length for the source queue SQ. When the queue is full, a new entry will be discarded if the weight of the new entry is smaller than the weight of the entry having the smallest weight. Otherwise, the latter is discarded and the new entry is sorted into the list.

The same method can also be applied to the target queue. Alternatively, or simultaneously, it can also be decided, immediately following determination of the weight of the current document, that this entry into the target queue as well as of its references into the source queue are not made if the weight falls below a predetermined threshold.

Until now, the method, when used with a very large pool such as the WWW, would only come to a standstill after a very long time, if at all. The target queue can be regularly displayed to the user for evaluation, so that he can interrupt the process if he considers the outcome to be sufficient.

Another possibility includes calculating a mean value of the weights of the documents stored in the target queue and interrupting the process once this mean value no longer increases following the addition of a predetermined number of documents. Once the target queue TQ has reached a preset maximum length and, as described above, documents having lower weight are discarded, this mean value can only increase, so that stagnation can serve as a discontinuation criterion.

It is certainly also possible to use a preset threshold, as described above, for entries into the source queue SQ. This will result in the source queue being empty at some point and, therefore, the process being terminated, in any case.

Because cyclical references are common in the document base of the WWW, it is preferable to maintain a list of the references already processed, generally in the form of a hash table, and to discard a reference from a document even before it is entered into the reference list. Alternatively, this task can be assumed by the agent or by a process designed for this purpose.

It is preferable to use a measure of dissimilarity based on the vector space model. Such a measure is described, for example, in “Introduction to Modern Information Retrieval,” by Gerald Salton, McGraw Hill 1983, p. 121-122. In this process, a table is initially compiled containing the words from the documents to be compared and their frequency. The frequent words with low significance, such as articles and conjunctions, are deleted from the table, generally at the time of its compilation and by way of so-called stop-word lists. Other measures can be found in the relevant literature. The frequency numbers form an n-dimensional vector for each document, wherein n is the number of words considered. A scalar product of the two vectors is used as the [measure of] dissimilarity between two documents. Words that appear in only one document are, of course, irrelevant in this context and can be eliminated in advance. The “cosine measure,” as described in the literature reference mentioned above, is preferably used as the scalar product. An overview of this topic can also be found in the thesis titled “Visualisierung latent semantischer Hypertext-Strukturen” [Visualization of latent semantic hypertext structures] by Hardy Höfer, University of Paderborn, December 1999, in Chapter 4.3.

The invention was described on the basis of the WWW as the document pool, in which documents exist as HTML documents that contain the references. Application to other document pools is easily possible, provided the documents exist in full text form and are linked with one another. This linkage can also occur through indices not included in the document. Whether the references are included in the document itself, in coded form, or in indices maintained in parallel appears to be irrelevant, as long as the addressing of the document in the index and vice-versa is clear. If documents are not present in full text form, but are accessible using one of the known clear text reading methods, the use of the invention becomes a matter of efficiency rather than principle, because, the documents are automatically supplied to the clear text reader and the texts obtained in this manner can be used. Incidentally, this is especially applicable to patents, in which references to other patents are easily located automatically once the document has been converted into full text by the clear text reader. Moreover, the citations of the patents are completely documented in relation to one another and, therefore, serve as an example of the external index mentioned above.

1. A method of compiling a list of documents maintained as a target queue, comprising:
determining a sequence relative to a document base by a weight determined through a predetermined method;
assigning references to other documents to the documents to be analyzed,
wherein a starting document is initially the current document, comprising:
determining, using an evaluator, the weight of the current document and places the document into the target queue on the basis of the weight,
removing the references included in the current document, and assigning the previously determined weight of the document, and,
together with the weight, are placed into a ranked source queue, and
removing the reference having the highest weight from the source queue by an agent, the corresponding document is retrieved and treated as the current document, and the steps are repeated.

2. The method as in claim 1, wherein each of several agents removes from the source queue a reference to the highest weight, retrieves the document, places the document in a buffer queue with the same weight as the reference, and the respective document having the highest weight is taken from the buffer queue and is treated as the current document.

3. The method as in claim 2, wherein a list of the references used is maintained and the references included in the list are not retrieved and analyzed again, such that references are not entered into the source queue or are discarded together with the highest weight during removal of the reference.

4. The method as in claim 1, wherein references having a preset minimum weight are entered into the source queue, and are otherwise discarded.

5. The method as in claim 1, wherein references having a preset minimum weight are entered into the target queue, and are otherwise discarded.

6. The method as in claim 1, wherein the source queue comprises a predetermined maximum number of entries and, when the number is reached, an entry having a low weight is discarded and an entry having a high weight displaces the entry having the lowest weight.

7. The method as in claim 1, wherein the target queue comprises a predetermined maximum number of entries and, when the number is reached, an entry having a low weight is discarded and an entry having a high weight displaces the entry having the lowest weight.

8. The method as in claim 1, wherein the document base comprises several documents.

9. The method as in claim 1, wherein a measure of dissimilarity used to determine dissimilarity between the current document and the document base is formed by a vector space model.
